(19) United States
(12) Patent Application Publication
(10) Pub. No.: US 2016/0262365 A1
(43) Pub. Date: Sep. 15, 2016

(54) Fly Exterminating Device

(71) Applicants: William VanDeKieft, Visalia, CA (US); William VanDeKieft, JR., Visalia, CA (US); Corey James VanDeKieft, Visalia, CA (US)

(72) Inventors: William VanDeKieft, Visalia, CA (US); William VanDeKieft, JR., Visalia, CA (US); Corey James VanDeKieft, Visalia, CA (US)

(21) Appl. No.: 15/045,479

(22) Filed: Feb. 17, 2016

Related U.S. Application Data
(60) Provisional application No. 62/131,423, filed on Mar. 11, 2015.

(51) Int. Cl. A01M 1/06; A01M 5/04

(52) U.S. Cl. CPC A01M 1/06; A01M 5/04

(57) ABSTRACT

A fly exterminating device for eliminating a conglomerate of flies, eggs, and larvae utilizes a blade assembly and a static-air vacuum-blower assembly. The blade assembly traverses along a stanchion line, scraping the concrete curb clean of eggs and larvae. Meanwhile, the static-air vacuum-blower assembly captures flies above the feed along the stanchion line and expels the flies away from the feed; along with the removed eggs and larvae. The blade assembly and the static-air vacuum-blower assembly are attached to a utility vehicle via a base frame. An extension arm assembly, pivotally connected in between the base frame and the blade assembly, allows the blade assembly to be raised and lowered, along with a vacuum hood that captures the flies and a blower nozzle that expels the flies. The extension arm assembly and the blade assembly are uniquely designed to traverse around stanchions with no interference.

The current application claims a priority to the U.S. Provisional Patent application Ser. No. 62/131,423 filed on Mar. 11, 2015.

### FIELD OF THE INVENTION

The present invention relates generally to an extermination device. More specifically, the present invention is a fly exterminating device meant to eliminate a large number of flies in areas such as dairy farms.

### BACKGROUND OF THE INVENTION

Flies are a constant issue for farmers, as they are unsanitary and carry and spread diseases. A common breeding ground for flies is along the stanchion line, where flies congregate above the feed and often lay eggs along the concrete curb positioned between the feed and the flushlane. The application of pesticides along the stanchion line is the most common method used for eliminating flies. In order to effectively eliminate the presence and breeding of flies, pesticides need to be applied frequently. The use of pesticides poses inherent health risks to the farmers who are exposed to the chemicals on a weekly or daily basis. While single exposure can be harmful in itself, repeated exposure to such chemicals over an extended period of time can lead to both short and long term medical conditions, some being life threatening. Despite the inherent risks in using pesticides, it is necessary to remove the flies and breeding larvae in order to prevent contamination of the feed and to prevent the spread of disease among cattle. Ideally, a chemical free method is devised for removing flies and breeding larvae to allow farmers to safely stop the spread of disease.

Therefore it is the object of the present invention to provide a fly exterminating device that is utilized to eliminate a large number of flies in areas such as dairy farms, without the use of chemicals. The present invention provides a blade assembly that is utilized to scrape eggs and larvae from breeding flies off of the concrete curb between the feed and the flushlane. Additionally, a static-air vacuum-blower assembly is utilized to suck up flies that congregate above the feed and blow the flies, along with the removed eggs and larvae, away from the feed, into the flushlane. Flies are captured through a vacuum hood and expelled from a blower nozzle positioned adjacent to the blade assembly. The blade assembly and the blower nozzle are connected to an extension arm assembly that is used to project the blade assembly and the blower nozzle away from a utility vehicle to which the present invention is attached. A lift assembly is used to raise and lower the vacuum hood and the extension arm assembly in order to position the vacuum hood above the feed and the blade assembly along the concrete curb. The blade assembly and the extension arm assembly provide a means for traversing around the stanchions, such that the blade assembly does not need to be repositioned as the utility vehicle traverses along the stanchion line.

### BRIEF DESCRIPTION OF THE DRAWINGS

FIG. 1 is a perspective view of the blade assembly being terminally positioned along the extension arm assembly.

FIG. 2 is a left sectional view of the blade assembly, detailing the scraper, the blade support frame, and the blade adjustment assembly.

FIG. 3 is a perspective view of the blade assembly and the extension arm assembly in conjunction with the base frame, the lift assembly, and the static-air vacuum-blower assembly.

FIG. 4 is a left side elevational view showing the connection of the vacuum hood to the lift mount via the hood mount.

FIG. 5 is right side elevational view showing the lift assembly used to raise and lower the lift mount in relation to the vehicle mount.

FIG. 6 is a top plan view showing the positioning of the blade assembly, the base frame, and the static-air vacuum-blower assembly in relation to the extension arm assembly.

FIG. 7 is a perspective view, wherein the present invention is attached to a utility vehicle via the vehicle mount.

### DETAIL DESCRIPTIONS OF THE INVENTION

All illustrations of the drawings are for the purpose of describing selected versions of the present invention and are not intended to limit the scope of the present invention.

The present invention is a fly exterminating device that is utilized to eliminate a large number of flies in areas such as dairy farms. The present invention is used to suck up flies atop of the feed along the stanchion line where the majority of the flies congregate. In addition to exterminating flies above the feed, the present invention eliminates the presence of fly eggs and larvae from flies breeding near the feed. In order to remove the eggs and larvae produced from the breeding flies, the present invention provides a means for scraping the concrete curb underneath the stanchions. Furthermore, the present invention provides a means for blowing the removed eggs, larvae, and flies away from the feed, into the flush lane, such that the feed is not contaminated.

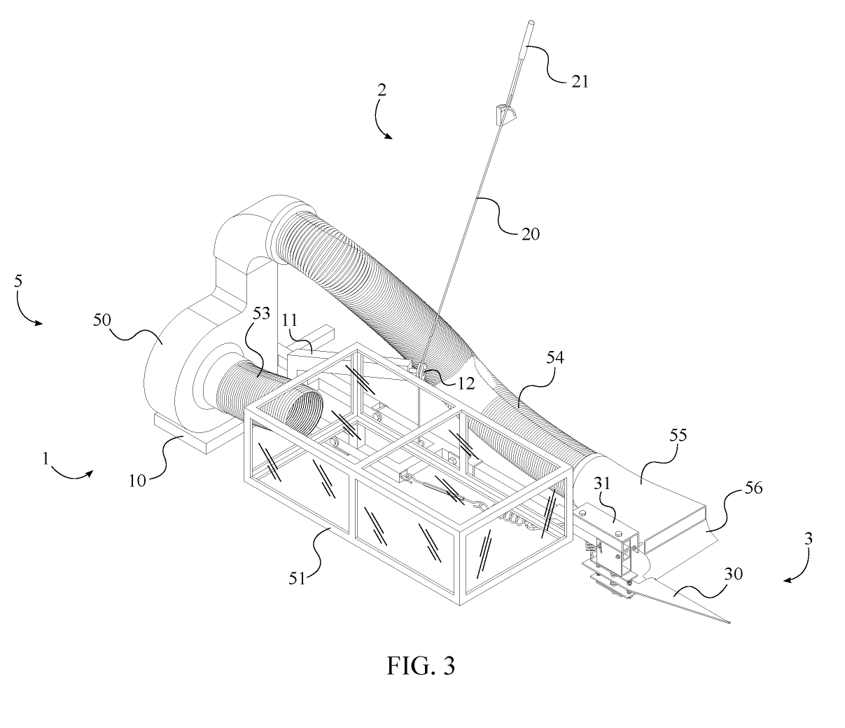

In reference to FIG. 3, the fly exterminating device comprises a blade assembly 3, an extension arm, a static-air vacuum-blower assembly 5, a base frame 1, and a lift assembly 2. The present invention is intended to be mounted on a utility vehicle that is able to traverse along the stanchions. As such, the base frame 1 provides a means for attaching the present invention to the utility vehicle. The extension arm assembly 4 projects the blade assembly 3 outwards, away from the utility vehicle, wherein the blade assembly 3 provides the means for scraping the concrete curb below the stanchions. The static-air vacuum-blower assembly 5 provides the means for suctioning flies away from the feed and blowing the flies into the flush lane, while simultaneously blowing the eggs and larvae removed by the blade assembly 3 into the flush lane. The lift assembly 2 allows a user to raise and lower the extension arm assembly 4, the blade assembly 3, and the static-air vacuum-blower assembly 5 from within the utility vehicle.

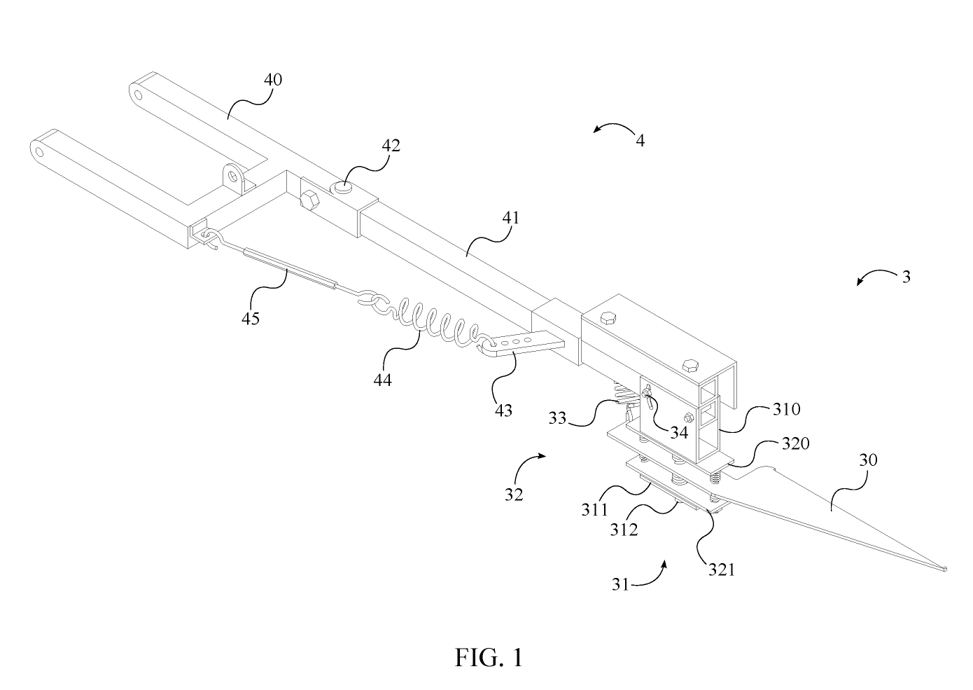

The blade assembly 3 aims to eliminate fly breeding from the onset by removing eggs and larvae often present on the concrete curb below the stanchions. As each curb structure can be different, the blade assembly 3 is height and angle adjustable to account for the variance between different curbs. In reference to FIG. 1, the blade assembly 3 comprises a scraper 30, a blade support frame 31, a blade adjustment assembly 32, a blade spring 33, and a blade angle-adjustment bolt 34. The scraper 30 provides a sharp edge that is run along the concrete curb, allowing the blade assembly 3 to scrape off the eggs and larvae from the breeding flies. In the preferred embodiment of the present invention, the scraper 30 is a J-blade, however, is possible for any other type of sharp edge to be utilized.

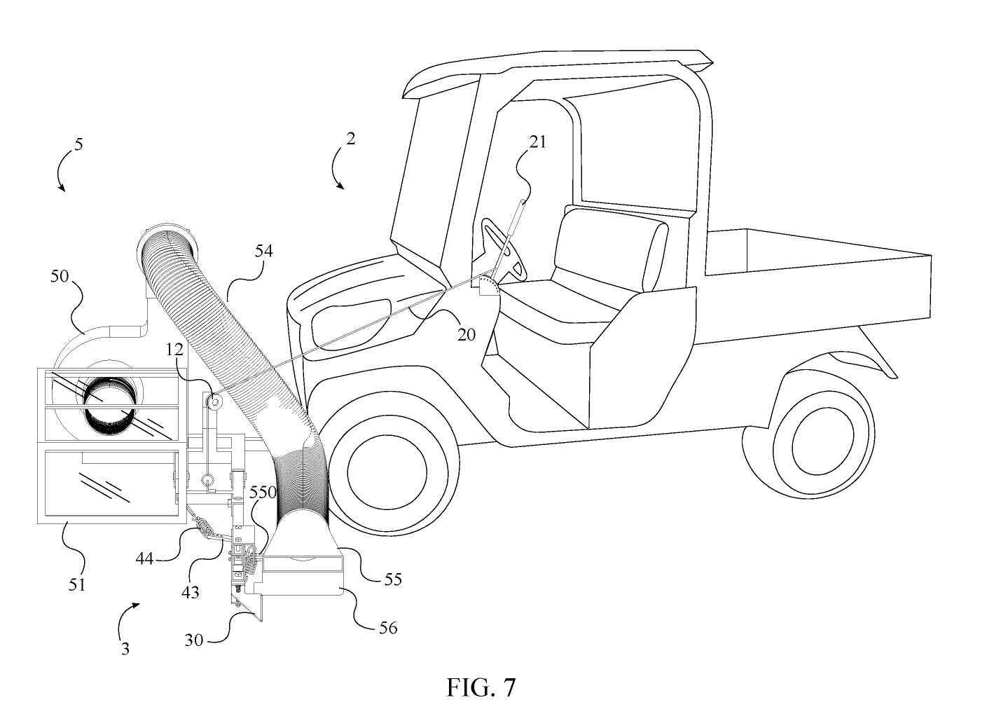

In further reference to FIG. 1, the blade assembly 3 is adjacently connected to the extension arm assembly 4, wherein the extension arm assembly 4 extends the blade assembly 3 away from the utility vehicle, as shown in FIG. 7. In order to do so, the extension arm assembly 4 comprises a lift mount 40, a breakaway arm 41, a breakaway spring bracket 43, and a breakaway spring 44. The lift mount 40 provides a connection to the base frame 1, while the breakaway arm 41 is pivotally connected to the lift mount 40 opposite the base frame 1. The breakaway arm 41 is pivotally connected to the lift mount 40 about a vertical axis, such that the breakaway arm 41 is able to move from right to left.

The breakaway arm 41 is nested within a coupler of the lift mount 40, wherein the coupler acts as an end plate for the breakaway arm 41, preventing the breakaway arm 41 from exceeding a 90 angle with the utility vehicle. As such, the breakaway arm 41 can be pivoted away from the coupler, to an angle less than 90 degrees relative to the utility vehicle. A breakaway pivot pin 42 traverses through the coupler and the breakaway arm 41, wherein the breakaway pivot pin 42 joins the breakaway arm 41 to the coupler while allowing the breakaway arm 41 to rotate about the breakaway pivot pin 42; the breakaway pivot pin 42 providing the vertical axis about which the breakaway arm 41 pivots.

In reference to FIG. 1, the breakaway spring bracket 43 is adjacently connected to the breakaway arm 41, and extends horizontally outwards, away from the breakaway arm 41. The breakaway spring 44 is adjacently connected to the breakaway spring bracket 43, wherein the breakaway spring 44 is connected in between the breakaway spring bracket 43 and the lift mount 40 with a turn buckle 45. The breakaway spring 44 serves to retain the breakaway arm 41 in the 90 degree position relative to the utility vehicle. When the breakaway arm 41 pivots away from the coupler, the breakaway spring 44 provides a restoring force to return and secure the breakaway arm 41 at the 90 degree angle. This allows the breakaway arm 41, and in turn the blade assembly 3, to move around the stanchion support posts using only the horizontal movement of the utility vehicle. As the breakaway arm 41 contacts the stanchion support posts, the breakaway arm 41 pivots, allowing the blade assembly 3 to move around the stanchion support posts. The breakaway spring 44 then returns the breakaway arm 41 to the angle necessary for scraping the concrete curb.

In the preferred embodiment of the present invention, the extension arm assembly 4 further comprises a turn buckle 45, as shown in FIG. 1. The turn buckle 45 is adjacently connected to the lift mount 40, while the breakaway spring 44 is terminally connected to the turn buckle 45 opposite the lift mount 40. The breakaway spring 44 can be positioned at different intervals along the breakaway spring bracket 43 depending on the spring force of the breakaway spring 44, or to alter the angular acceleration of the breakaway arm 41. The turn buckle 45 allows the user to easily adjust the position of the breakaway spring 44 along the breakaway spring bracket 43 or replace the breakaway spring 44. Additionally, the turn buckle 45 can be used to adjust the tension in the breakaway spring 44 in order to achieve the desired restoring force.

The blade support frame 31 is terminally positioned on the breakaway arm 41 opposite the lift mount 40 and provides a mount for both the blade adjustment assembly 32 and the scraper 30. The blade support frame 31 is pivotally connected to the breakaway arm 41, such that the angle of both the scraper 30 and the blade adjustment assembly 32, in relation to the concrete curb, can be adjusted. The blade support frame 31 can be pivoted about a horizontal axis in order to angle the scraper 30 and the blade adjustment assembly 32 upwards and downwards. The blade angle-adjustment bolt 34 traverses through the blade support frame 31 and the breakaway arm 41 and is used to lock the blade support frame 31 in position at the desired angle in relation to the breakaway arm 41.

In the preferred embodiment of the present invention, the blade angle-adjustment bolt 34 is threaded to engage with a nut, wherein the nut can be tightened or loosened in order to position the blade support frame 31. The blade support frame 31 pivots about a stationary bolt, while an arced cut in the blade support frame 31 allows the blade support frame 31 to slide around the blade angle-adjustment bolt 34. Once the blade support frame 31 is positioned, the nut is tightened on the blade adjustment assembly 32 to secure the blade support frame 31 at the desired angle. In other embodiments of the present invention the blade angle-adjustment could be a ball lock pin, hitch pin, or other similar mechanism used to secure the blade support frame 31 at the desired angle.

Both the scraper 30 and the blade adjustment assembly 32 are pivotally connected to the blade support frame 31. The blade support frame 31 extends away from the breakaway arm 41, wherein the scraper 30 and the blade adjustment assembly 32 are positioned along the blade support frame 31 opposite the breakaway arm 41. The scraper 30 and the blade adjustment assembly 32 can be pivoted about a longitudinal axis of the blade support frame 31, wherein the angle of the longitudinal axis varies according to the angle of the blade support frame 31 in relation to the breakaway arm 41. Similar to the pivotal nature of the breakaway arm 41, the pivotal nature of the scraper 30 and the blade adjustment assembly 32 allows the scraper 30 to move around the stanchion support posts as the scraper 30 traverses along the concrete curb.

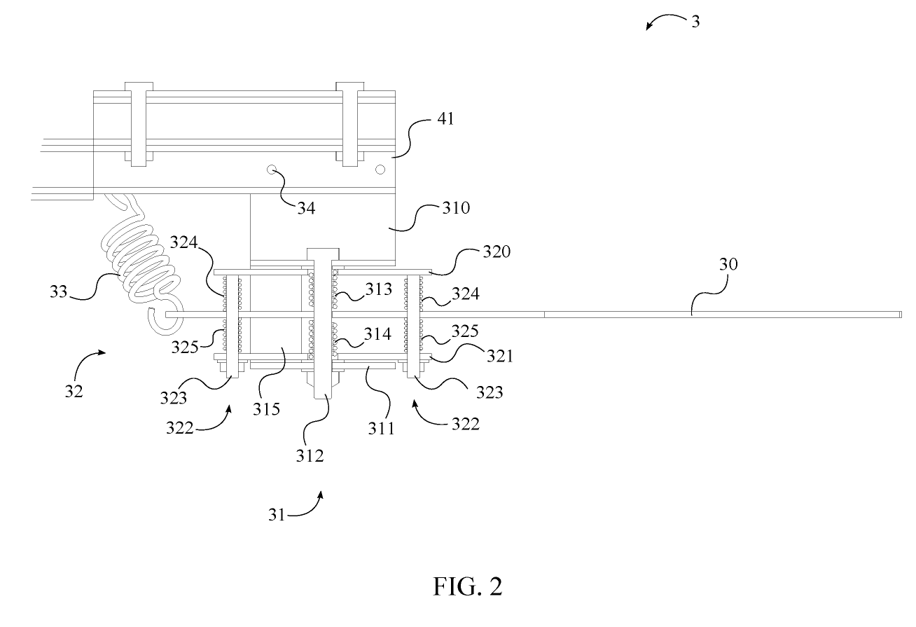

The blade adjustment assembly 32 allows the user to fine tune the angle of the scraper 30. Additionally, the blade adjustment assembly 32 allows the scraper 30 to traverse more easily over uneven surfaces. To allow for the adjustment of the scraper 30, the blade adjustment assembly 32 comprises a first spring-guide plate 320, a second spring-guide plate 321, and an at least one guide assembly 322. In reference to FIG. 2, the first spring-guide plate 320 and the second spring-guide plate 321 are pivotally connected to the blade support frame 31, wherein the scraper 30 is positioned in between the first spring-guide plate 320 and the second spring-guide plate 321. The at least one spring guide assembly is adjacently connected to the first spring-guide plate 320, while the second spring-guide plate 321 is slidably connected to the at least one guide assembly 322. By varying the position of the second spring-guide plate 321 along the at least one guide assembly 322, the angle of the scraper 30 and the position of the scraper 30 along the at least one guide can be adjusted.

In the preferred embodiment of the present invention and in reference to FIG. 2, each of the at least one guide assembly 322 comprises a guide pin 323, a first spring 324, and a second spring 325. The guide pin 323 is adjacently connected to the first spring-guide plate 320, while the second spring-guide plate 321 is slidably connected to the guide pin 323, wherein the guide pin 323 traverses through the scraper 30. Furthermore, the guide pin 323 traverses through the first spring 324 and the second spring 325, wherein the first spring 324 is positioned in between the first spring-guide plate 320 and the scraper 30, and the second spring 325 is positioned in between the second spring-guide plate 321 and the scraper 30. The guide pin 323 is threaded, such that a nut positioned adjacent to the second spring-guide plate 321, opposite the second spring 325, can be tightened and loosened in order to adjust the position of the scraper 30 along the guide pin 323.

By tightening the nut, the second spring-guide plate 321 is pushed along the guide pin 323, towards the first spring-guide plate 320, wherein the first spring 324 and the second spring 325 are compressed and the scraper 30 is in turn moved towards the first spring-guide plate 320. By loosening the nut, the first spring 324 and the second spring 325 are decompressed, wherein both the scraper 30 and the second spring-guide plate 321 are pushed along the guide pin 323, away from the first spring-guide plate 320. The angle of the scraper 30 can be adjusted by tightening the nut of one guide pin 323 more so than the nut of another guide pin 323. For example, if the at least one guide assembly 322 is specifically a first guide assembly and a second guide assembly, having a first guide pin and a second guide pin respectively, then the nut of the first guide pin can be tightened more than the nut of the second guide pin, and vice versa, in order to change the angle of the scraper 30 in relation to the blade support frame 31.

In reference to FIG. 2, the blade support frame 31 comprises main body 310, an end plate 311, a blade pivot bolt 312, a first pivot-bolt spring 313, and a second pivot-bolt spring 314. The main body 310 is the section of the blade support frame 31 that is pivotally connected to the breakaway arm 41, while the blade pivot bolt 312 provides the means by which the scraper 30 and the blade adjustment assembly 32 are pivotally connected to the blade support frame 31. The blade pivot bolt 312 traverses through the main body 310 opposite the breakaway arm 41, and through the scraper 30, the first spring-guide plate 320, the second spring-guide plate 321, the first pivot-bolt spring 313, the second pivot-bolt spring 314, and the end plate 311. The first pivot-bolt spring 313 is positioned in between the first spring-guide plate 320 and the scraper 30, wherein the first pivot-bolt spring 313 traverses through the first spring-guide plate 320. Meanwhile, the second pivot-bolt spring 314 is positioned in between the second spring-guide plate 321 and the scraper 30, wherein the second pivot-bolt spring 314 traverses through the second spring-guide plate 321.

In further reference to FIG. 2, the end plate 311 is positioned along the blade pivot bolt 312 opposite the main body 310, wherein the blade adjustment assembly 32 and the scraper 30 are positioned in between the main body 310 and the end plate 311. The blade pivot bolt 312 is threaded, such that a nut positioned adjacent to the end plate 311, opposite the second pivot-bolt spring 314, can be tightened and loosened in order to adjust the position of the blade adjustment assembly 32 and the scraper 30 along the blade pivot bolt 312. By tightening the nut, the end plate 311 is pushed along the blade pivot bolt 312, towards the main body 310, wherein the first pivot-bolt spring 313 and the second pivot-bolt spring 314 are compressed and both the blade adjustment assembly 32 and the scraper 30 are in turn moved towards the main body 310. By loosening the nut, the first pivot-bolt spring 313 and the second pivot-bolt spring 314 are decompressed, wherein the blade adjustment assembly 32, the scraper 30, and the end plate 311 are pushed along the blade pivot bolt 312, away from the main body 310. In this way, the height of the blade can be set by positioning the scraper 30 along the length of the blade pivot bolt 312.

In reference to FIG. 2, the blade support frame 31 further comprises a stop 315 to prevent the scraper 30 from pivoting past a certain position when moving in the direction to scrape the concrete curb. The stop 315 is adjacently connected to the main body 310 and is positioned along the main body 310 opposite the breakaway arm 41, wherein the blade adjustment assembly 32 and the scraper 30 are positioned adjacent to the stop 315. Furthermore, the end plate 311 is terminally connected to the stop 315 opposite the main body 310. When the utility vehicle is moving in the direction to scrape the concrete curb, the stop 315 prevents the blade adjustment assembly 32 and the scraper 30 from freely pivoting, keeping the scraper 30 perpendicular to the concrete curb. However, when the utility vehicle moves in the opposite direction, the blade adjustment assembly 32 and the scraper 30 are able to pivot, allowing the scraper 30 move around the stanchion support posts.

The blade spring 33 is used to restore the scraper 30 to the perpendicular position with the concrete curb after the scraper 30 pivots around the stanchion support posts. In reference to FIG. 1-2, the blade spring 33 is positioned in between the breakaway arm 41 and the scraper 30, wherein the blade spring 33 is adjacently connected to breakaway arm 41 and the scraper 30 is terminally connected to the blade spring 33 opposite the breakaway arm 41. When the scraper 30 pivots around the stanchion support posts, the blade spring 33 is tensioned, wherein the spring force of the blade spring 33 returns the scraper 30 to the initial position; the stop 315 stopping the scraper 30 at the initial position.

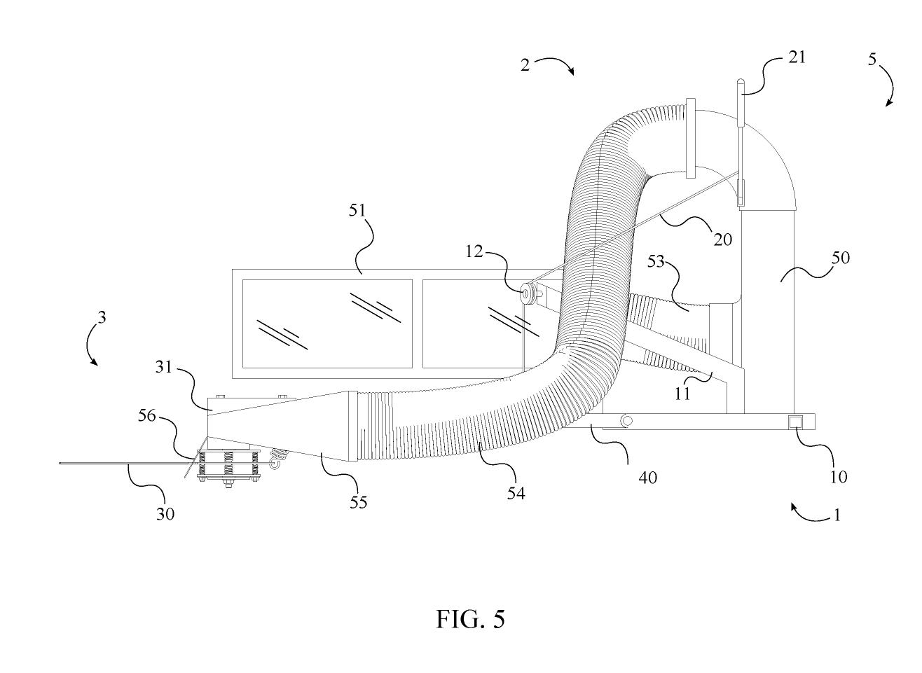

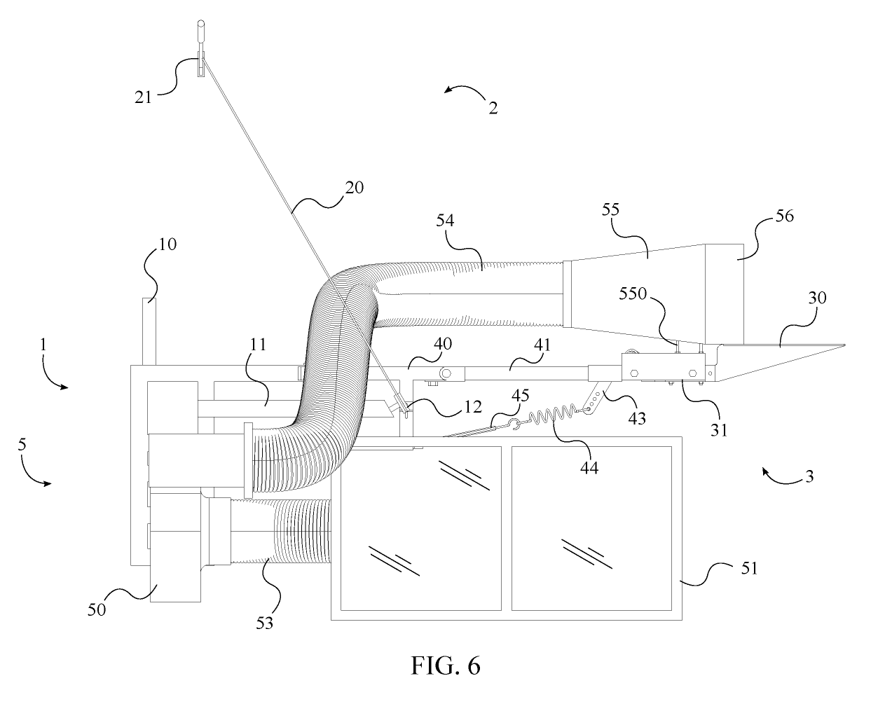

As the blade assembly 3 scrapes the eggs and larvae off of the concrete curb, the static-air vacuum-blower assembly 5 blows the eggs and larvae away from the feed. In order to do so, the static-air vacuum-blower assembly 5 comprises an air blower 50, an outgoing duct 54, a blower nozzle 55, and a back flow flap 56. In reference to FIG. 5-6, the outgoing duct 54 is connected in between the air blower 50 and the blower nozzle 55, wherein the blower nozzle 55 is in fluid communication with the air blower 50 through the outgoing duct 54. The blower nozzle 55 is pivotally connected to the breakaway arm 41 opposite the lift mount 40 and is positioned adjacent to the blade assembly 3.

Air is expelled from the air blower 50, through the outgoing duct 54 and out of the blower nozzle 55. The blower nozzle 55 is positioned such that air blows across the concrete curb away from the feed so that the eggs and larvae are blown away from the concrete curb as the eggs and larvae are scraped from the concrete curb. The back flow flap 56 is hingedly connected to the blower nozzle 55 and positioned across the blower nozzle 55 opposite the outgoing duct 54. The back flow flap 56 rests on the concrete curb, such that there is no gap between the concrete curb and the blower nozzle 55, ensuring that no eggs or larvae are scraped into the feed.

In reference to FIG. 6, the blower nozzle 55 comprises a blower angle-adjustment bolt 550 that allows the angle of the blower nozzle 55, and in turn the angle of the flow of air, in relation to the concrete curb to be adjusted by the user. The hinged connection of the back flow flap 56 to the blower nozzle 55, allows the blower nozzle 55 to be set at any angle while ensuring that there is no gap between the blower nozzle 55 and the feed. The blower angle-adjustment bolt 550 traverses through the breakaway arm 41 and is used to lock the blower nozzle 55 in position at the desired angle in relation to the concrete curb. The blower angle-adjustment bolt 550 functions in a similar manner to the blade angle-adjustment bolt 34 used to set the blade support frame 31.

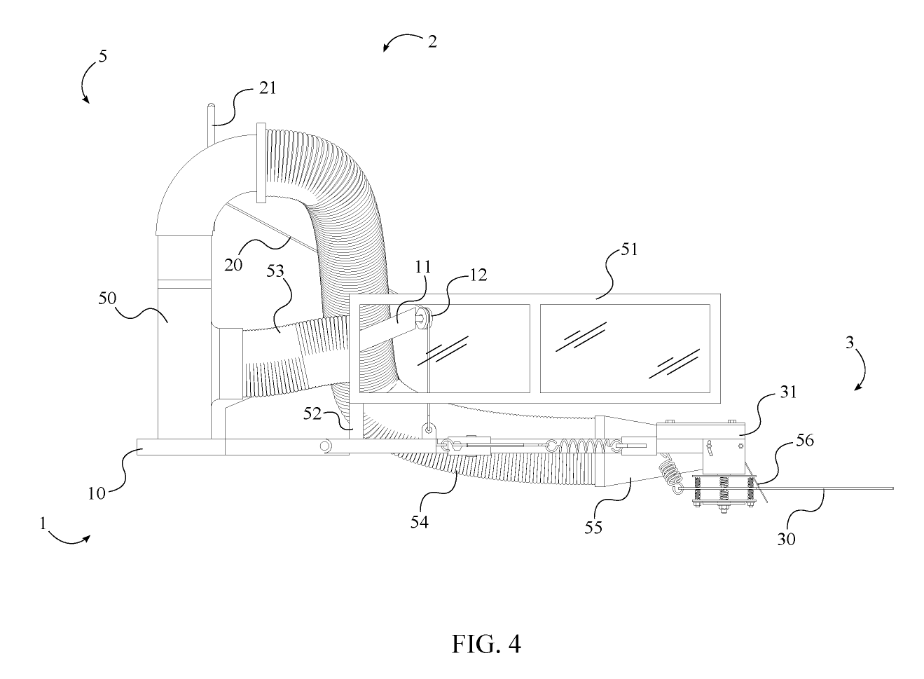

The static-air vacuum-blower assembly 5 further comprises a vacuum hood 51, a hood mount 52, and an incoming duct 53. In reference to FIG. 4, the incoming duct 53 is connected in between the air blower 50 and the vacuum hood 51, wherein the vacuum hood 51 is in fluid communication with the air blower 50 through the incoming duct 53. The vacuum hood 51 is positioned overtop of the feed, wherein the vacuum hood 51 is used to suck up flies as the air blower 50 pulls in air through the vacuum hood 51 and the incoming duct 53. The flies are then expelled through the outgoing duct 54 and away from the feed via the blower nozzle 55.

In further reference to FIG. 4, the vacuum hood 51 is positioned via the hood mount 52. The hood mount 52 is adjacently connected to the lift mount 40, wherein the hood mount 52 projects upwards away from the lift mount 40. The vacuum hood 51 is terminally connected to the hood mount 52 opposite the lift mount 40, such that the vacuum hood 51 is raised upwards and positioned above the feed. adjacent to the extension arm assembly 4.

The base frame 1 is the component that allows the blade assembly 3, the extension arm assembly 4, and the static-air vacuum-blower assembly 5 to be mounted onto the utility vehicle, as shown in FIG. 7. Additionally, the base frame 1 provides components for vertically raising and lowering the blade assembly 3, the extension arm assembly 4, the vacuum hood 51, and the blower nozzle 55. In reference to FIG. 5-6, the base frame 1 comprises a vehicle mount 10, a lift arm 11, and a pulley 12, wherein the vehicle mount 10 is connected to the utility vehicle. The lift mount 40 is pivotally connected to the vehicle mount 10 opposite the utility vehicle, wherein the lift mount 40 is positioned in between the vehicle mount 10 and the breakaway arm 41.

The lift arm 11 is adjacently connected to the vehicle mount 10, while the pulley 12 is adjacently connected to the lift arm 11 opposite the vehicle mount 10. The lift arm 11 extends the pulley 12 away from the vehicle mount 10 and positions the pulley 12 above the lift mount 40. The lift arm 11 and the pulley 12 are used in conjunction with the lift assembly 2 to raise and lower the lift mount 40. The lift assembly 2 comprises a wire 20 and a control arm 21, wherein the control arm 21 is positioned on or adjacent to the utility vehicle, within reach of the user. The wire 20 is terminally connected to the lift and the control arm 21, and is slidably engaged with the pulley 12, wherein the pulley 12 is positioned in between the lift mount 40 and the control arm 21.

In reference to FIG. 7, the wire 20 extends vertically between the lift mount 40 and the pulley 12, and is angled away from the pulley 12 to the control arm 21. When the control arm 21 is pulled back, the wire 20 is pulled along the pulley 12, wherein lift mount 40 is raised, and in turn the blade assembly 3, the extension arm assembly 4, the vacuum hood 51, and the blower nozzle 55 are raised. When the control arm 21 is released, or moved forward, the lift mount 40 is lowered. This allows the user to easily position the vacuum hood 51 above the feed, and position the blade assembly 3 and the blower nozzle 55 along the concrete curb. The air blower 50 is adjacently connected to the vehicle mount 10 in a fixed position as it is more efficient for raising and lowering the lift mount 40. It is not necessary to raise and lower the air blower 50 as the incoming duct 53 and the outgoing duct 54 are both flexible to allow for the vertical movement of the vacuum hood 51 and the blower nozzle 55 respectively.

Although the invention has been explained in relation to its preferred embodiment, it is to be understood that many other possible modifications and variations can be made without departing from the spirit and scope of the invention as hereinafter claimed.

What is claimed is:

1. A fly exterminating device comprises:
a blade assembly;
an extension arm assembly;
the blade assembly comprises a scraper, a blade support frame, a blade adjustment assembly, and a blade spring;
the extension arm assembly comprises a lift mount, a breakaway arm, a breakaway spring bracket, and a breakaway spring;
the breakaway arm being pivotally connected to the lift mount;
the blade support frame being pivotally connected to the breakaway arm opposite the lift mount;
the blade support frame being terminally positioned on the breakaway arm;
the blade adjustment assembly and the scraper being pivotally connected to the blade support frame;
the blade adjustment assembly and the scraper being positioned along the blade support frame opposite the breakaway arm;
the blade spring being adjacently connected to the breakaway arm;
the scraper being terminally connected to the blade spring opposite the breakaway arm;
the breakaway spring bracket being adjacently connected to the breakaway arm;
the breakaway spring being adjacently connected to the breakaway spring bracket; and
the breakaway spring being connected in between the breakaway spring bracket and the lift mount.

2. The fly exterminating device as claimed in claim 1 comprises:
the blade assembly further comprises a blade angle-adjustment bolt; and
the blade angle-adjustment bolt traversing through the blade support frame and the breakaway arm, wherein the blade angle-adjustment bolt sets the angle of the blade support frame in relation to the breakaway arm.

3. The fly exterminating device as claimed in claim 1 comprises:
the blade adjustment assembly comprises a first spring-guide plate, a second spring-guide plate, and an at least one guide assembly;
the first spring-guide plate and the second spring-guide plate being pivotally connected to the blade support frame;
the at least one guide assembly being adjacently connected to the first spring-guide plate; and
the second spring-guide plate being slidably connected to the at least one guide assembly.

4. The fly exterminating device as claimed in claim 3 comprises:
each of the at least one guide assembly comprises a guide pin;
the guide pin being adjacently connected to the first spring-guide plate;
the second spring-guide plate being slidably connected to the guide pin; and
the guide pin traversing through the scraper.

5. The fly exterminating device as claimed in claim 3 comprises:
each of the at least one guide assembly comprises a guide pin, a first spring, and a second spring;
the guide pin traversing through the first spring and the second spring;
the first spring being positioned in between the first spring-guide plate and the scraper; and
the second spring being positioned in between the second spring-guide plate and the scraper.

6. The fly exterminating device as claimed in claim 1 comprises:
the blade support frame comprises a main body and a catch;
the catch being adjacently connected to the main body;
the catch being positioned along the main body opposite the breakaway arm; and
the scraper and the blade adjustment assembly being positioned adjacent to the catch.

7. The fly exterminating device as claimed in claim 1 comprises:
the blade support frame comprises a main body, a stop, and a blade pivot bolt;
the blade adjustment assembly comprises a first spring-guide plate and a second spring-guide plate;
the blade pivot bolt traversing through the main body, the stop, the scraper, the first spring-guide plate, and the second spring-guide plate; and
the stop being positioned along the pivot bolt opposite the main body.

8. The fly exterminating device as claimed in claim 7 comprises:
the blade support frame further comprises a first pivot-bolt spring and a second pivot-bolt spring;
the pivot bolt traversing through the first pivot-bolt spring and the second pivot-bolt spring;
the first pivot-bolt spring being positioned in between the main body and the first spring-guide plate; and
the second pivot-bolt spring being positioned in between the stop and the second spring-guide plate.

9. The fly exterminating device as claimed in claim 1 comprises:
the extension arm assembly further comprises a turn buckle;
the turn buckle being adjacently connected to the lift mount; and
the breakaway spring being terminally connected to the turn buckle opposite the lift mount.

10. The fly exterminating device as claimed in claim 1 comprises:
a base frame;
the base frame comprises a vehicle mount;
the lift mount being pivotally connected to the vehicle mount; and
the lift mount being positioned in between the vehicle mount and the breakaway arm.

11. The fly exterminating device as claimed in claim 1 comprises:
a base frame;
the base frame comprises a vehicle mount, a lift arm, and a pulley;
the lift arm being adjacently connected to the vehicle mount; and
the pulley being adjacently connected to the lift arm opposite the vehicle mount.

12. The fly exterminating device as claimed in claim 1 comprises:
a lift assembly;
the lift assembly comprises a wire and a control arm; and
the wire being terminally connected to the lift mount and the control arm.

13. The fly exterminating device as claimed in claim 12 comprises:
a base frame;
the base frame comprises a pulley;
the pulley being positioned in between the lift mount and the control arm; and
the wire being slidably engaged with the pulley.

14. The fly exterminating device as claimed in claim 1 comprises:
a static-air vacuum-blower assembly;
the static-air vacuum-blower assembly comprises an air blower, a vacuum hood, a blower nozzle, and a back flow flap;
the air blower being in fluid communication with the vacuum hood and the blower nozzle; and
the back flow flap being hingedly connected to the blower nozzle.

15. The fly exterminating device as claimed in claim 14 comprises:
the static-air vacuum-blower assembly further comprises an incoming duct;
the incoming duct being connected in between the air blower and the vacuum hood; and
the incoming duct being in fluid communication with the vacuum hood and the air blower.

16. The fly exterminating device as claimed in claim 14 comprises:
the static-air vacuum-blower assembly further comprises an outgoing duct;
the outgoing duct being connected in between the air blower and the blower nozzle;
the outgoing duct being in fluid communication with the blower nozzle and the air blower; and
the back flow flap being positioned across the blower nozzle opposite the outgoing duct.

17. The fly exterminating device as claimed in claim 14 comprises:
the static-air vacuum-blower assembly further comprises a hood mount;
the hood mount being adjacently connected to the lift mount; and
the vacuum hood being terminally connected to the hood mount opposite the lift mount.

18. The fly exterminating device as claimed in claim 14 comprises:
the blower nozzle being pivotally connected to the breakaway arm opposite the lift mount; and
the blower nozzle being positioned adjacent to the blade assembly.

19. The fly exterminating device as claimed in claim 18 comprises:
the blower nozzle comprises a blower angle-adjustment bolt; and
the blower angle-adjustment bolt traversing through the breakaway arm, wherein the blower angle-adjustment bolt sets the angle of the blower nozzle in relation to the breakaway arm.

20. The fly exterminating device as claimed in claim 14 comprises:
a base frame;
the base frame comprises a vehicle mount; and
the air blower being adjacently connected to the vehicle mount.
